(19) United States
(12) Patent Application Publication
(10) Pub. No.: US 2007/0104585 A1
(43) Pub. Date: May 10, 2007

(54) Metal component, turbine component, gas turbine engine, surface processing method, and steam turbine engine

(75) Inventors: Hiroyuki Ochiai, Tokyo (JP); Mitsutoshi Watanabe, Tokyo (JP); Mikiya Arai, Tokyo (JP); Akihiro Goto, Tokyo (JP); Masao Akiyoshi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Ishikawajima-Harima Heavy Industries Co., Ltd., Tokyo (JP); Mitsubishi Denki Kabushiki Kaisha, Tokyo (JP)

(21) Appl. No.: 10/560,360

(22) PCT Filed: Jun. 10, 2004
(86) PCT No.: PCT/JP04/08130

§ 371 Date: Nov. 16, 2006

(30) Foreign Application Priority Data
Jun. 10, 2003 (JP) 2003-165403
Feb. 5, 2004 (JP) 2004-029970

(51) Int. Cl. F03B 3/12

(52) U.S. Cl. 416/241 R

(57) ABSTRACT

Formation of a protective coating having oxidation resistance on a portion to be processed of a component main body by employing an electrode composed of a molded body molded from mixed powders of one or more of an aluminum powder, an aluminum alloy powder, a chromium powder and a chromium alloy powder, or the molded body processed with a heat treatment, generating a pulsing electric discharge between the portion to be processed of the component main body and the electrode in an electrically insulating liquid or gas so that an electrode material of the electrode is adhered to the portion to be processed of the component main body by energy of the electric discharges, and further keeping the portion to be processed of the component main body and the electrode material adhered thereto in high temperatures so that the electrode material adhered thereto diffuses into a base material of the component main body.

### TECHNICAL FIELD

The present invention relates to a metal component, a component of a turbine, a gas turbine engine, a surface treatment method thereof and a steam turbine engine.

### BACKGROUND ART

A turbine airfoil used in a gas turbine engine for a jet engine and such is provided with an airfoil body as a main body of a component. As well, in general, portions to be processed of the airfoil body, such as airfoil faces of the airfoil in the airfoil body, are processed with a surface treatment so as to ensure oxidation resistance.

More specifically, by processing an aluminizing treatment to the portions to be processed of the airfoil body by employing a hydrogen furnace, aluminum is adhered to the portions to be processed of the airfoil body. Further, by keeping the airfoil body and aluminum adhered thereto in high temperatures by employing the hydrogen furnace or another heat treatment furnace, aluminum is diffused into a base material of the airfoil body. Thereby, the turbine airfoil can be finally produced with forming protective coatings having oxidation resistance on the portions to be processed of the airfoil body.

### DISCLOSURE OF INVENTION

By the way, before adhering aluminum to the portions to be processed of the airfoil body, a blast treatment to the portions to be processed of the airfoil body and a masking treatment to portions except the portions to be processed in the airfoil body are necessary to be processed. Further after adhering aluminum to the portions to be processed of the airfoil body, a removing treatment is necessary to be processed. Therefore, process steps required to production of the turbine airfoil are increased so that the production time of the turbine airfoil is elongated and hence there is a problem that improvement of productivity of the turbine airfoil is not easy.

Meanwhile, in cases where surface treatments to portions to be processed of any metal components are processed to ensure oxidation resistance, the aforementioned problem similarly occurs.

A first feature of the present invention is provided with a component main body; a protective coating having oxidation resistance formed on a portion to be processed of the component main body, wherein the protective coating is formed by employing a molded body molded from mixed powders of one or more of an aluminum powder, an aluminum alloy powder, a chromium powder and a chromium alloy powder, or the molded body processed with a heat treatment, as an electrode, generating a pulsing electric discharge between the portion to be processed of the component main body and the electrode in an electrically insulating liquid or gas so that an electrode material of the electrode is adhered to the portion to be processed of the component main body by energy of the electric discharges, and keeping the portion to be processed of the component main body and the electrode material adhered thereto in high temperatures so that the electrode material adhered thereto diffuses into a base material of the component main body.

A second feature of the present invention is provided with a component main body; and a protective coating having oxidation resistance formed on a portion to be processed of the component main body, which is composed of SiC, wherein the coating is formed by employing an electrode composed of a molded body molded from a solid substance of Si and a powder of Si or the molded body processed with a heat treatment and generating pulsing electric discharge between the portion to be processed of the component main body and the electrode in an electrically insulating liquid including an alkane hydrocarbon so that an electrode material of the electrode or a reaction substance of the electrode material carries out deposition, diffusion and/or welding on the portion to be processed of the component main body by energy of the electric discharges.

### BRIEF DESCRIPTION OF DRAWINGS

FIG. 1 A schematic drawing of a gas turbine engine in accordance with embodiments of the present invention.

FIG. 2 FIG. 2(a) is a cross sectional view taken from a IIA-IIA line of FIG. 2(b) and FIG. 2(b) is a side view of a turbine airfoil in accordance with a first embodiment.

FIG. 3 A side view of an electric spark machine in accordance with the embodiments.

FIG. 4 FIG. 4(a) and FIG. 4(b) are drawings for explaining a surface treatment method in accordance with the first embodiment.

FIG. 5 FIG. 5(a) and FIG. 5(b) are drawings for explaining the surface treatment method in accordance with the first embodiment.

FIG. 6 A schematic drawing of a steam engine in accordance with a first embodiment.

FIG. 7 A side view of a turbine airfoil in accordance with the second embodiment.

FIG. 8 FIG. 8(a) is an overhead view of FIG. 8(b) and FIG. 8(b) is a drawing for explaining a surface treatment method in accordance with the second embodiment.

FIG. 9 FIG. 9(a) is an overhead view of FIG. 9(b) and FIG. 9(b) is a drawing for explaining the surface treatment method in accordance with the second embodiment.

FIG. 10 A side view of a turbine airfoil in accordance with a modified version of a fifth embodiment.

### BEST MODE FOR CARRYING OUT THE INVENTION

A description will be hereinafter given to certain embodiments of the present invention for describing the present invention in further detail with appropriate reference to the accompanying drawings. Meanwhile, in the drawings, “FF” denotes a forward direction and “FR” denotes a rearward direction. Moreover, in the description, in proper, “a cross direction” is referred to as an X-axis direction, “a horizontal direction” is referred to as a Y-axis direction and “a vertical direction” is referred to as a Z-axis direction.

### First Embodiment

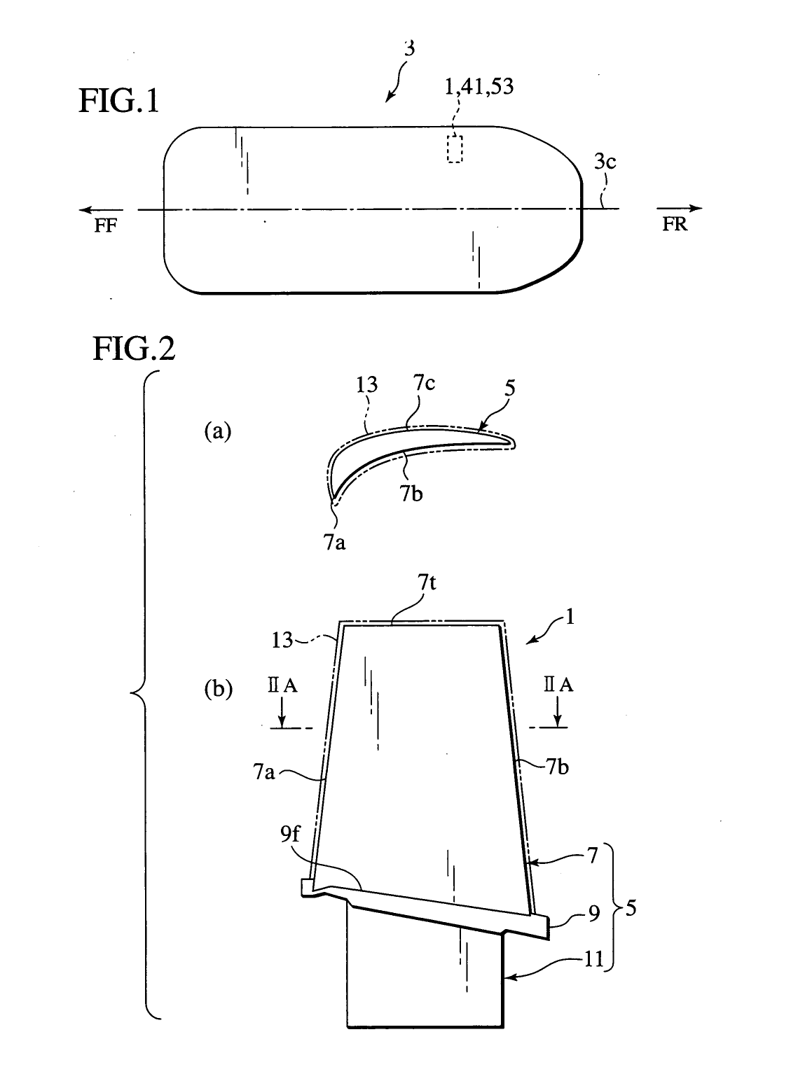

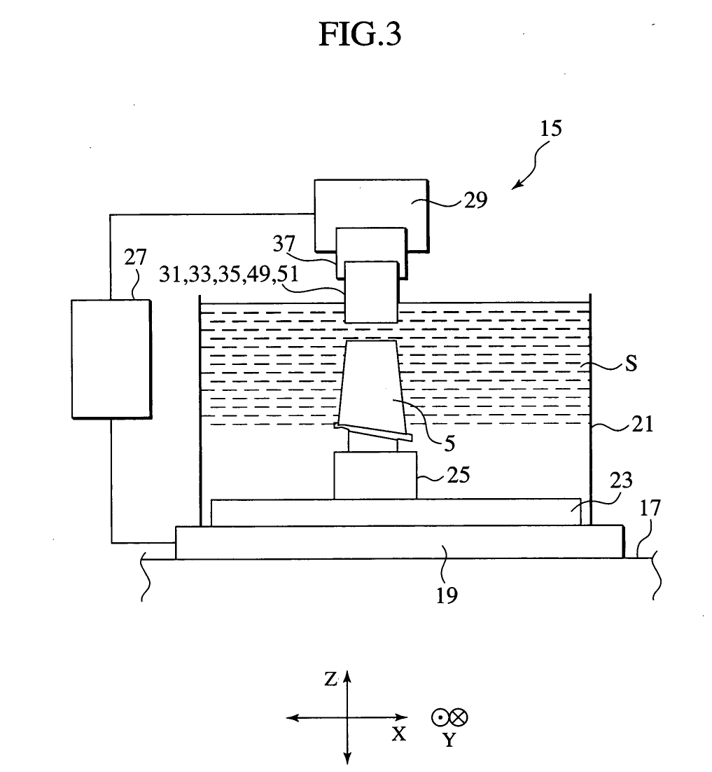

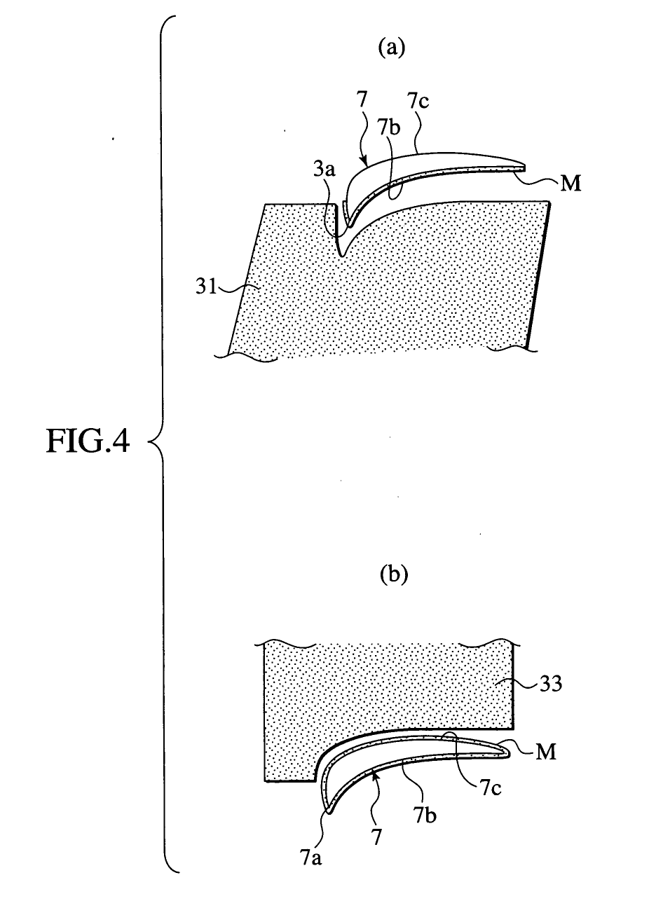

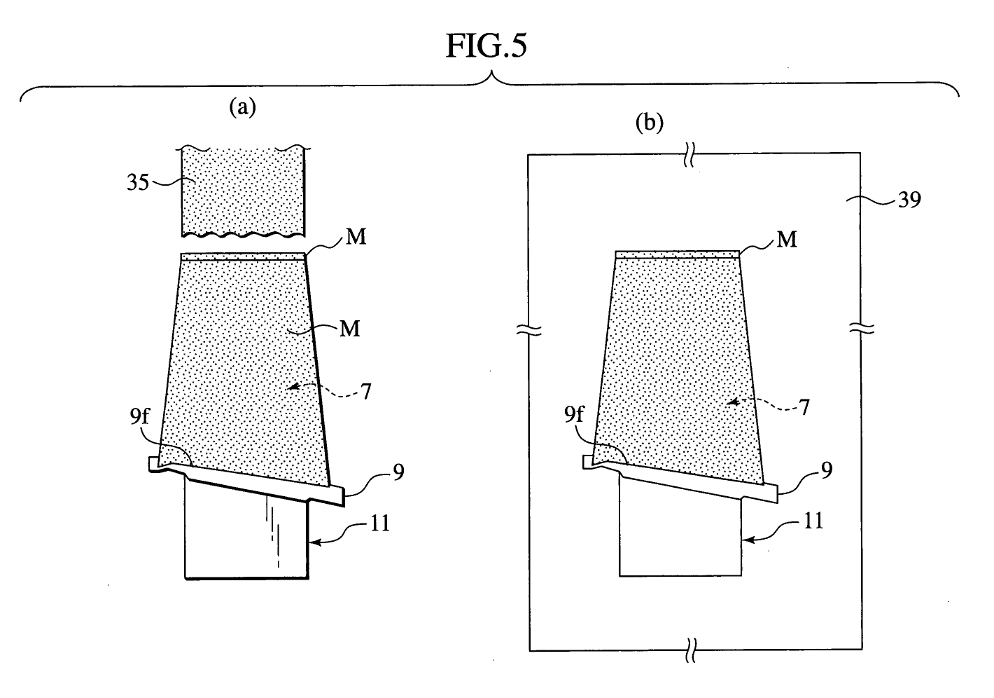

A first embodiment will be described hereinafter with reference to FIG. 1, FIG. 2(a), FIG. 2(b), FIG. 3, FIG. 4(a), FIG. 4(b), FIG. 5(a) and FIG. 5(b).

As shown in FIG. 1, a turbine airfoil 1 in accordance with the first embodiment is one of turbine components employed in a gas turbine engine 3 of a jet engine and such and is rotatable around an axial center 3c of the gas turbine engine 3.

A shown in FIG. 2(a) and FIG. 2(b), the turbine airfoil 1 is provided with an airfoil main body 5 as a component main body and the airfoil main body 5 is composed of an airfoil 7, a platform 9 formed in a unitary body with a proximal side of the airfoil 7 and a dovetail 11 formed at the platform 9. Here, the platform 9 has a flow pathway face 9f for a combustion gas and the dovetail 11 is engagable with a dovetail gutter (not shown) of a turbine disk (not shown). Meanwhile, a portion ranging from a leading edge 7a to a pressure sidewall 7b of the airfoil 7, a suction sidewall 7c, a tip end face 7t and the flow pathway face 9f of the platform 9 serve as portions to be processed.

And, based on a novel surface treatment method in accordance with the first embodiment, the portion ranging from the leading edge 7a to the pressure sidewall 7b of the airfoil 7, the suction side wall 7c, the tip end face 7t and the flow pathway face 9f of the platform 9 are processed with the surface treatment so as to ensure oxidation resistance. In other words, a protective coating 13 of novel configuration having oxidation resistance is formed on the portion ranging from the leading edge 7a to the pressure sidewall 7b of the airfoil 7, the suction sidewall 7c, the tip end face 7t and the flow pathway face 9f of the platform 9 and a surface side of the protective coating 13 is processed with a peening treatment.

Before describing the novel surface treatment in accordance with the first embodiment, an electric spark machine 15 employed for the surface treatment with respect to the portions to be processed of the component main body in the turbine components such as the portions to be processed of the airfoil main body 5 will be described with reference to FIG. 3.

As shown in FIG. 3, the electric spark machine 15 is provided with a bed 17 extending in an X-axis direction and a Y-axis direction. Further, the bed 17 is provided with a table 19 and the table 19 is movable in the X-axis direction by means of a drive of an X-axis servo motor (not shown) and movable in the Y-axis direction by means of a drive of a Y-axis servo motor (not shown).

The table 19 is provided with a processing tank 21 for reserving a liquid S of electrical insulation including alkane hydrocarbons such as an oil and, in the processing tank 21, a support plate 23 is provided. The support plate 23 is provided with a jig 25 to which the component main body such as the airfoil main body 5 is capable of setting and the jig 25 is electrically connected to an electric power source 27. Meanwhile, an attitude of the component main body is capable of being changed and FIG. 3 shows a condition in which the airfoil main body 5 is set so as to direct the tip end face 7t of the airfoil 7 upward.

Above the bed 17, a processing head 29 is provided with interposing a column (not shown) and the processing head 29 is movable in a Z-axis direction by means of a drive of a Z-axis servo motor (not shown). The processing head 29 is provided with a support member 37 for supporting electrodes 31, 33 and 35 and such described later and the support member 37 is electrically connected to the electric power source 27.

Next, the surface treatment method in accordance with the first embodiment will be described.

The surface treatment method of the first embodiment is, as follows, provided with an adhering step, a diffusion step and a peening step.

(I) Adhering Step

First, the electrode 31 is supported by the support member 37 and the airfoil main body 5 is set at the jig 25 so as to direct the pressure sidewall 7b of the airfoil 7 upward. Next, by means of driving the X-axis servo motor and the Y-axis servo motor, the table 19 is moved in the X-axis direction and the Y-axis direction to position the airfoil main body 5 so that the portion ranging from the leading edge 7a to the pressure sidewall 7b of the airfoil 7 is opposed to the electrode 31. Meanwhile, there may be a case where the table 19 is only necessary to be moved in any of the X-axis direction and the Y-axis direction.

Further, as shown in FIG. 4(a), a pulsing electric discharge is generated between the portion ranging from the leading edge 7a to the pressure sidewall 7b of the airfoil main body 5 and the electrode 31 and further between the pressure side of the flow pathway face 9f of the platform 9 (in FIG. 4(a), the platform 9 is omitted to be shown) and the electrode 31 in the liquid S of electrical insulation. Thereby, by means of energy of the electric discharges, the electrode material M of the electrode 31 can be adhered on the portion ranging from the leading edge 7a to the pressure sidewall 7b of the airfoil main body 5 and the pressure side of the flow pathway face 9f of the platform 9.

Here, the electrode 31 is composed of a molded body molded by compressing aluminum powder or aluminum alloy powder by means of pressing, or the molded body processed with a heat treatment by means of a vacuum furnace or such. Meanwhile, instead of molding by compressing, the electrode 31 may be formed by slurry pouring, MIM (Metal Injection Molding), spray forming and such. Moreover, a tip end of the electrode 31 shows a shape similar to the portion ranging from the leading edge 7a to the pressure sidewall 7b of the airfoil 7.

After adhering the electrode material M of the electrode 31, the electrode 31 is detached from the support member 37 and the electrode 33 is supported by the support member 37, and the airfoil main body 5 is set at the jig 25 so as to direct the suction sidewall 7c of the airfoil 7 upward. Next, by means of driving the X-axis servo motor and the Y-axis servo motor, the table 19 is moved in the X-axis direction and the Y-axis direction to position the airfoil main body 5 so that the suction sidewall 7c of the airfoil 7 is opposed to the electrode 33. Meanwhile, there may be a case where the table 19 is only necessary to be moved in any of the X-axis direction and the Y-axis direction.

And, a pulsing electric discharge is generated between the suction sidewall 7c of the airfoil 7 and the electrode 33 and further between the suction side of the flow pathway face 9f of the platform 9 (in FIG. 4(a), the platform 9 is omitted to be shown) and the electrode 33 in the liquid S of electrical insulation. Thereby, by means of energy of the electric discharges, the electrode material M of the electrode 33 can be adhered on the suction sidewall 7c of the airfoil 7 and the suction side of the flow pathway face 9f of the platform 9.

Here, the electrode 33 is, similarly to the electrode 31, composed of a molded body molded by compressing aluminum powder or aluminum alloy powder by means of pressing, or the molded body processed with a heat treatment by means of a vacuum furnace and such. Meanwhile, instead of molding by compressing, the electrode 33 may be formed by slurry pouring, MIM (Metal Injection Molding), spray forming and such. Moreover, a tip end of the electrode 33 shows a shape similar to the suction sidewall 7c of the airfoil 7.

After adhering the electrode material M of the electrode 33, the electrode 33 is detached from the support member 37 and the electrode 35 is supported by the support member 37, and the airfoil main body 5 is set at the jig 25 so as to direct the tip end face 7t of the airfoil 7 upward. Next, by means of driving the X-axis servo motor and the Y-axis servo motor, the table 19 is moved in the X-axis direction and the Y-axis direction to position the airfoil main body 5 so that the tip end face 7t of the airfoil 7 is opposed to the electrode 35. Meanwhile, there may be a case where the table 19 is only necessary to be moved in any of the X-axis direction and the Y-axis direction.

And, a pulsing electric discharge is generated between the tip end face 7t of the airfoil 7 and the electrode 35. Thereby, by means of energy of the electric discharges, the electrode material M of the electrode 35 can be adhered on the tip end face 7t of the airfoil 7.

Here, the electrode 35 is, similarly to the electrode 33, composed of a molded body molded by compressing aluminum powder or aluminum alloy powder by means of pressing, or the molded body processed with a heat treatment by means of a vacuum furnace and such. Meanwhile, instead of molding by compressing, the electrode 35 may be formed by slurry pouring, MIM (Metal Injection Molding), spray forming and such. Moreover, a tip end of the electrode 35 shows a shape similar to the shape of the tip end face 7t of the airfoil 7.

Meanwhile, when generating the pulsing discharges, the electrode 31, 33 or 35, as being integral with the processing head 29, is reciprocated in the Z-axis direction by a small travel distance. Moreover, instead of generating the pulsing discharges in the liquid S of electrical insulation, pulsing discharges may be generated in a gas of electrical insulation.

(II) Diffusion step

After finishing the (I) adhering step, as shown in FIG. 5(b) the airfoil main body 5 is detached from the jig 25 and set in a predetermined position in a heat treatment furnace 39. Further, the airfoil main body 5 and the electrode material adhered thereto are kept in high temperatures from 950 degrees C. to 1100 degrees C. by means of the heat treatment furnace. Thereby, the electrode material M can be diffused into the base material of the airfoil main body 5 so as to form a protective coating 13 composed of intermetallic compounds of Nickel-Aluminum.

(III) Peening Step

After finishing the (II) diffusion step, the airfoil main body 5 is detached form the jig 25 and set in a predetermined position of a peening machine (not shown). Further, the surface side of the protective coating 13 is processed with the peening treatment. As concrete modes of the peening treatment, a shot-peening treatment using shot (see Japanese Patent Application Laid-open No. 2001-170866, 2001-260027 and 2000-225567, for example) and a laser-peening treatment using laser (see Japanese Patent Application Laid-open No. 2002-236112 and 2002-239759, for example) are exemplified.

Then the production of the turbine airfoil 1 is finished.

Next, operations of the embodiment of the first embodiment will be described.

First, because the electrode material M can be adhered on the portion ranging from the leading edge 7a to the pressure sidewall 7b of the airfoil 7, the suction sidewall 7c, the tip end face 7t and the flow pathway face 9f of the platform 9 by means of the energy of the electric discharges, a range where the electrode material M is adhered can be limited and hence a masking treatment and any treatments accompanying the masking treatment can be omitted. Meanwhile, the treatments accompanying the masking treatment are a blast treatment and a removal treatment of the mask.

Moreover, for the same reason, a part of the electrode material M adhered thereto comes to be already accompanied with initial diffusion into the base material of the airfoil main body 5.

Furthermore, because the surface side of the protective coating 13 is processed with the peening treatment, residual compression stress can be given to the surface side of the protective coating 13.

Therefore, in accordance with the first embodiment, because the range where the electrode material M is adhered can be limited in a range where the electric discharges are generated, a number of process steps required to the production of the turbine airfoil can be cut down. Moreover, because the part of the electrode material M adhered thereto is already accompanied with the initial diffusion into the base material of the airfoil main body 5, in the (II) diffusion step, the electrode material M adhered thereto can be at an early stage diffused into the base material of the airfoil main body 5. Therefore, the production time of the turbine airfoil 1 can be shortened and the productivity of the turbine airfoil 1 can be easily increased.

Moreover, because the residual compression stress can be given to the surface side of the protective coating 13, fatigue strength of the protective coating 13 can be improved and the life of the turbine airfoil 1 can be elongated.

Meanwhile, the present invention is not limited to the description of the embodiment of the first embodiment and can be enabled by various embodiments as described in the following.

More specifically, instead of using the electrodes 31, 33 and 35 composed of molded bodies molded by compressing aluminum powder or aluminum alloy powder by means of pressing, another electrode composed of a molded body molded by compressing chromium powder or chromium alloy powder by means of pressing, or the molded body processed with a heat treatment by means of a vacuum furnace and such may be used to form another protective coating having oxidation resistance. Meanwhile, in this case, another protective coating is improved in a property of resistance to corrosion by collision of alien substances, in other words, erosion resistance in particular.

Moreover, the present invention can be, not limited to the turbine component such as the turbine airfoil 1, applied to various metal components.

### Second Embodiment

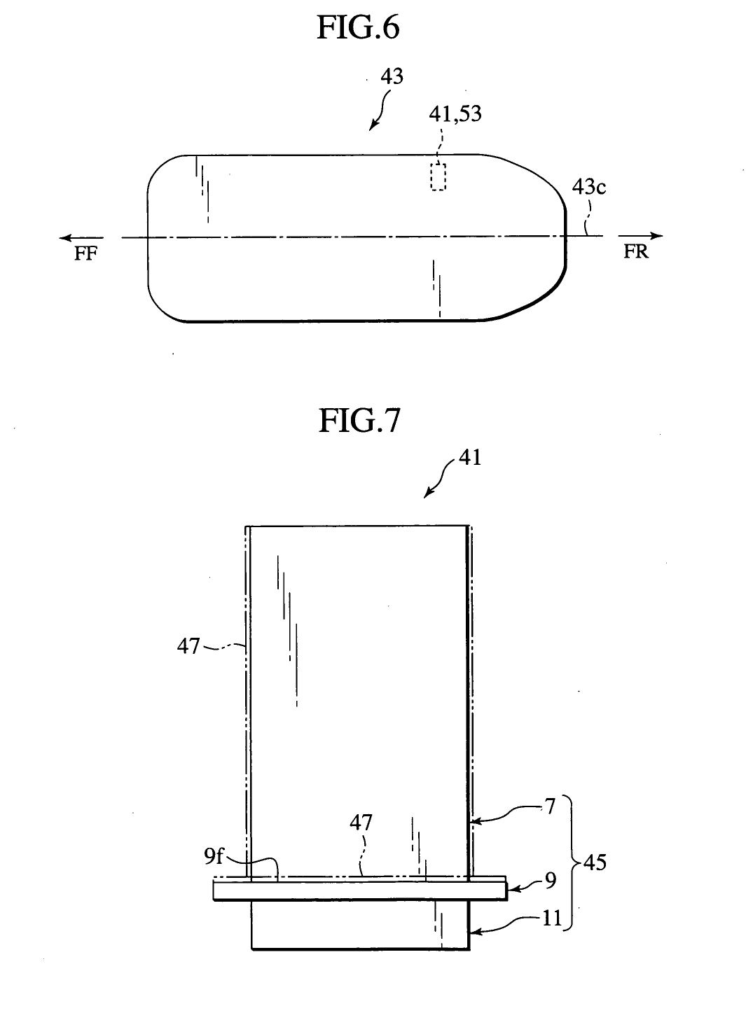

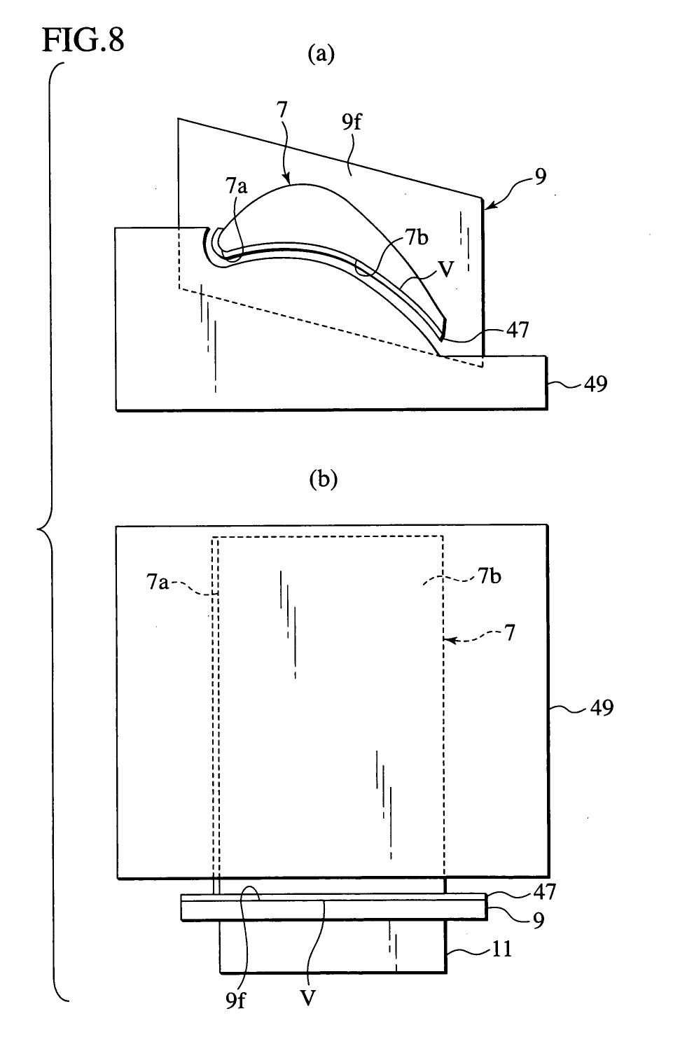

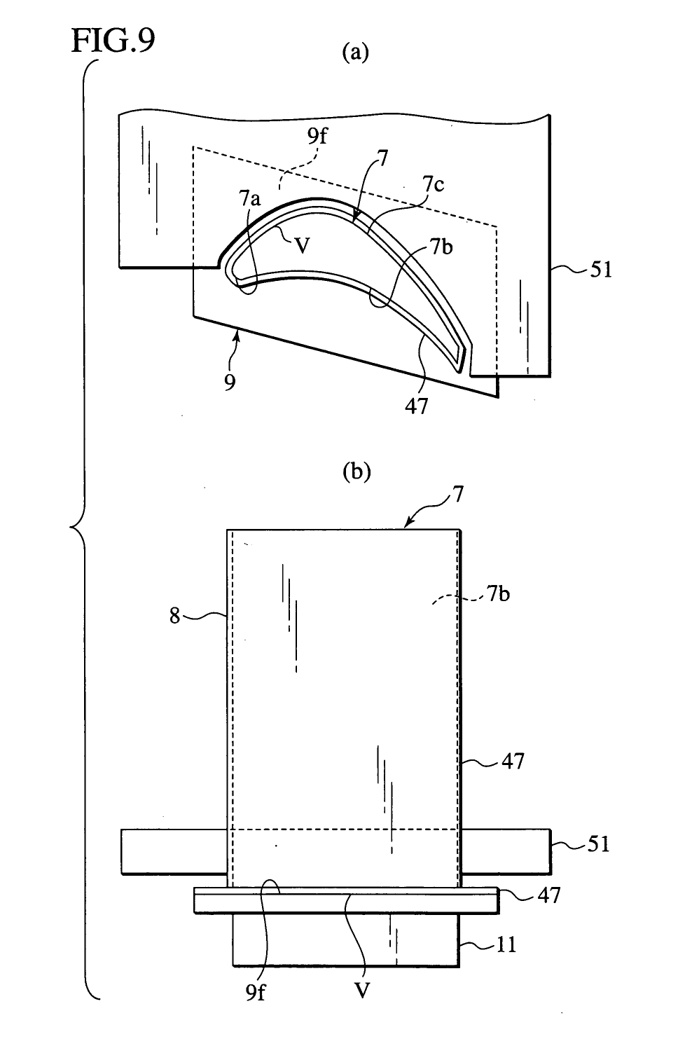

A second embodiment will be described hereinafter with reference to FIG. 1, FIG. 3, FIG. 6, FIG. 7, FIG. 8(a), FIG. 8(b), FIG. 9(a) and FIG. 9(b).

As shown in FIG. 1 and FIG. 6, a turbine airfoil 41 in accordance with the second embodiment is one of airfoil components used in the gas turbine engine 3 or a steam turbine engine 43 and is rotatable around the axial center 3c of the gas turbine engine 3 or an axial center 43c of the steam turbine engine 43.

As shown in FIG. 7, the turbine airfoil 41 in accordance with the second embodiment is provided with an airfoil main body 45 as a component main body and the airfoil main body 45 is, as similar to the turbine airfoil 1 in accordance with the first embodiment, composed of the airfoil 7, the platform 9 and the dovetail 11. Meanwhile, the portion ranging from the leading edge 7a to the pressure sidewall 7b of the airfoil 7, the suction sidewall 7c and the flow pathway face 9f of the platform 9 serve as portions to be processed.

And, the portion ranging from the leading edge 7a to the pressure sidewall 7b of the airfoil 7 and the flow pathway face 9f of the platform 9 are processed with the surface treatment so as to ensure oxidation resistance. In other words, a hard protective coating 47 composed of novel configuration having oxidation resistance is formed the portion ranging from the leading edge 7a to the pressure side wall 7b of the airfoil 7, the suction sidewall 7c, the tip end face 7t and the flow pathway face 9f of the platform 9 by means of the energy of the electric discharges and a surface side of the protective coating 47 is processed with the peening treatment. Meanwhile, the protective coating 47 is composed of SiC.

More specifically, a major part of the protective coating 47 is formed by employing the electric spark machine 15 shown in FIG. 3 in accordance with the embodiment and an electrode 49 shown in FIG. 8(a) and FIG. 8(b), generating pulsing electric discharges respectively between the portion ranging from the leading edge 7a to the pressure sidewall 7b of the airfoil 7 and the electrode 49 and between the pressure side part of the flow pathway face 9f of the platform 9 and the electrode 49 in an electrically insulating liquid S including an alkane hydrocarbon so that an electrode material of the electrode 49 or a reaction substance of the electrode material carries out deposition, diffusion and/or welding on the portion ranging from the leading edge 7a to the pressure sidewall 7b of the airfoil 7 and the pressure side part of the flow pathway face 9f of the platform 9.

Here, the electrode 49 is composed of a molded body molded by compressing a solid body of Si and powder of Si by means of pressing, or the molded body processed with a heat treatment by means of a vacuum furnace and such. Meanwhile, instead of molding by compressing, the electrode 49 may be formed by slurry pouring, MIM (Metal Injection Molding), spray forming and such. Moreover, a tip end of the electrode 49 shows a shape similar to the shape of the portion ranging from the leading edge 7a to the pressure sidewall 7b of the airfoil 7.

Moreover, “deposition, diffusion and/or welding” means all meanings including “desposition”, “diffusion”, “welding”, “mixed phenomena of deposition and diffusion”, “mixed phenomena of deposition and welding”, “mixed phenomena of diffusion and welding” and “mixed phenomena of deposition, diffusion and welding”.

Further, the remaining part of the protective coating 47 is formed by employing the electric spark machine 15 shown in FIG. 3 in accordance with the embodiment and an electrode 51 shown in FIG. 9(a) and FIG. 9(b), generating pulsing electric discharges respectively between the suction sidewall 7c of the airfoil 7 and the electrode 49 and between the suction side part of the flow pathway face 9f of the platform 9 and the electrode 49 in an electrically insulating liquid S including an alkane hydrocarbon so that an electrode material of the electrode 51 or a reaction substance of the electrode material carries out deposition, diffusion and/or welding on the suction sidewall 7c of the airfoil 7 and the suction side part of the flow pathway face 9f of the platform 9.

Here, the electrode 51 is composed of a molded body molded by compressing a solid body of Si and powder of Si by means of pressing, or the molded body processed with a heat treatment by means of a vacuum furnace and such. Meanwhile, instead of molding by compressing, the electrode 51 may be formed by slurry pouring, MIM (Metal Injection Molding), spray forming and such. Moreover, a tip end of the electrode 51 shows a shape similar to the suction sidewall 7c of the airfoil 7.

Moreover, after forming the protective coating 47, a surface side of the protective coating 47 is processed with a peening treatment. As concrete modes of the peening treatment, a shot-peening treatment using shot and a laser-peening treatment using laser are exemplified.

Next, operations of the second embodiment will be described.

First, because the protective coating 47 is formed by means of energy of the electric discharges, a range of the protective coating 47 can be limited in a range where the electric discharges are generated and hence a masking treatment and any treatments accompanying the masking treatment can be omitted.

Moreover, for the same reason, a boundary part B between the protective coating 47 formed by means of the energy of the electric discharges and the base material of the airfoil main body 45 has a structure in which the composition ratio grades so that the protective coating 47 and the base material of the airfoil main body 45 can be firmly combined.

Furthermore, because the surface side of the protective coating 47 is processed with the peening treatment, residual compression stress can be given to the surface side of the protective coating 47.

In accordance with the second embodiment as mentioned above, because the range of the protective coating 47 can be limited to the range where the electric discharges are generated and the masking treatment and any treatments accompanying the masking treatment can be omitted, a number of process steps required to the production of the turbine airfoil can be cut down. Therefore, the production time of the turbine airfoil 41 can be shortened and the productivity of the turbine airfoil 41 can be easily increased.

Moreover, because the protective coating 47 and the airfoil main body 45 can be firmly combined, the protective coating 47 is insusceptible to peeling off from the base material of the airfoil main body 45 and quality of the turbine airfoil 41 is stabilized.

Furthermore, because the residual compression stress can be given to the surface side of the protective coating 47, fatigue strength of the protective coating 47 can be improved and the life of the turbine airfoil 41 can be elongated.

Meanwhile, the present invention is not limited to the description of the second embodiment described above and any modification such that any surface treatment method based on the novel surface treatment method is processed with respect to any portion to be processed of a component main body in any airfoil component except the turbine airfoil 41, or any portion to be processed of a component main body in any metal component except the airfoil component and such.

### MODIFIED EXAMPLE

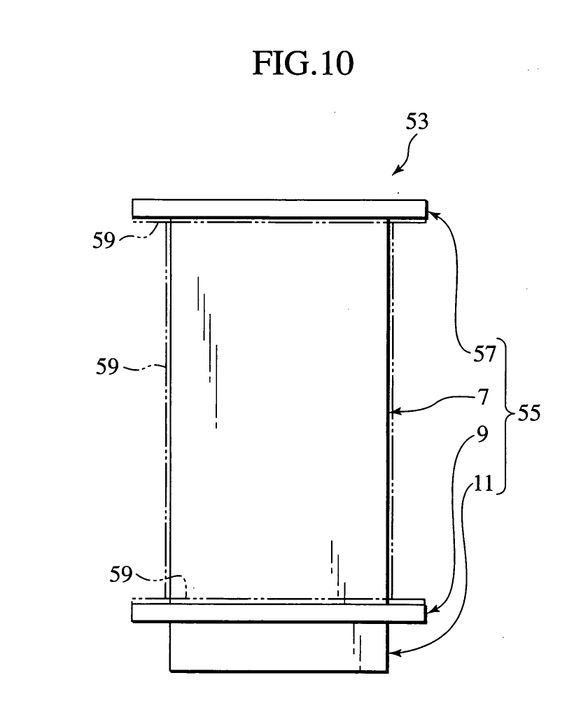

Next, a modified example of the second embodiment will be described hereinafter with reference to FIG. 1, FIG. 6 and FIG. 10.

As shown in FIG. 1 and FIG. 6, a turbine airfoil 53 in accordance with the modified example of the second embodiment is, as similar to the turbine airfoil 41, one of airfoil components used in the gas turbine engine 3 or the steam engine 43 and is rotatable around the axial center 3c of the gas turbine engine 3 or the axial center 43c of the steam turbine engine 43.

Moreover, as shown in FIG. 10, the turbine airfoil 53 in accordance with the modified example of the second embodiment is provided with an airfoil main body 55 as a component main body and the airfoil main body 55 is composed of the airfoil 7, the platform 9, the dovetail 11 and a shroud 57 formed at the tip end of the airfoil 7. Here, the shroud 57 has a flow pathway face 57f for a combustion gas. Meanwhile, the portion ranging from the leading edge 7a to the pressure sidewall 7b of the airfoil 7, the suction sidewall 7c, the flow pathway face 9f of the platform 9 and the flow pathway face 57f of the shroud 57 serve as portions to be processed of the airfoil main body 57.

And, a hard protective coating 59 having erosion resistance is formed on the portion ranging from the leading edge 7a to the pressure side wall 7b of the airfoil 7, the suction sidewall 7c of the airfoil 7, the flow pathway face 9f of the platform 9 and the flow pathway face 57f of the shroud 57.

Meanwhile, in the modified example of the second embodiment, operations and effects similar to the second embodiment described above are achieved.

As described above, the invention has been described above by reference to several preferable embodiments, however, the scope of right included in the present invention is not limited to these embodiments.

Moreover, the contents of Japanese Patent Application No. 20004-029970 filed with the Japan Patent Office on Feb. 5, 2004 and the contents of Japanese Patent Application No. 20003-165403 filed with the Japan Patent Office on Jun. 10, 2003 should have been cited in the contents of the present application by reference.

1-16. (canceled)

17. An airfoil of a rotor or a stator of a turbine engine, comprising:
a main body including a suction sidewall faced to a suction side, a pressure sidewall opposed to the suction sidewall, a leading edge, a trailing edge opposed to the leading edge, a tip end face at an axially outer end of the main body, and a platform at an axially inner end of the main body, the platform including a flow pathway and a dovetail; and
a protective coating coated on the leading edge, the suction sidewall, the pressure sidewall, the tip end face, and the flow pathway, the protective coating including one or more oxidation-resistant metals selected from the group consisting of aluminum, chromium, aluminum alloys, and chromium alloys, and being formed by processing a portion as a workpiece of an electric spark machine with a tool electrode including the oxidation-resistant metals and kept in temperatures from 950° C. to 1100° C.

18. The airfoil of claim 17, wherein the protective coating is given residual compression stress by a peening treatment.

19. A gas turbine engine comprising the airfoil of claim 17.

20. A method for surface-treatment of a component of a turbine engine, comprising:
depositing a coating of an oxidation-resistant metal on a portion of an untreated component by processing a portion as a workpiece of an electric spark machine with a tool electrode of the oxidation-resistant metal; and
keeping the coating and the component in temperatures from 950° C. to 1100° C. to diffuse the coating into the component; and
processing the coating with a peening treatment.

21. The method of claim 20, wherein the portion is limited to a leading edge, a suction sidewall, a pressure sidewall, a tip end face, and a flow pathway of the component by making the tool electrode to approach the portion.

22. An airfoil surface-treated by the method of claim 20.

23. An airfoil of a rotor or a stator of a turbine engine, comprising:
a main body including a suction sidewall faced to a suction side, a pressure sidewall opposed to the suction sidewall, a leading edge, a trailing edge opposed to the leading edge, a tip end face at an axially outer end of the main body, and a platform at an axially inner end of the main body, the platform including a flow pathway and a dovetail;
a protective coating coated on the leading edge, the suction sidewall, the pressure sidewall, the tip end face, and the flow pathway, the protective coating including SiC and being formed by processing a portion as a workpiece of an electric spark machine with a tool electrode including Si in a liquid including alkane hydrocarbons.

24. The airfoil of claim 23, wherein the protective coating is given residual compression stress by a peening treatment.

25. A gas turbine engine comprising the airfoil of claim 23.

26. A method for surface-treatment of a component of a turbine engine, comprising:
forming a coating including SiC coated on a portion of an untreated component by processing a portion as a workpiece of an electric spark machine with a tool electrode of Si in a liquid including alkane hydrocarbons.

27. The method of claim 26, further comprising:
processing the coating with a peening treatment.

28. The method of claim 26, wherein the portion is limited to a leading edge, a suction sidewall, a pressure sidewall, a tip end face, and a flow pathway of the component by making the tool electrode to approach the portion.

29. An airfoil surface-treated by the method of claim 26.
